(19) United States
(12) Patent Application Publication
(10) Pub. No.: US 2011/0153466 A1
(43) Pub. Date: Jun. 23, 2011

(54) SENSOR BASED INVENTORY MANAGEMENT SYSTEM AND METHOD

(76) Inventors: DIVYASIMHA HARISH, Fremont, CA (US); Jonathan T. Lim, Fremont, CA (US); Aravamudhan Soundararajan, Milpitas, CA (US); King Wong, Saratoga, CA (US)

(21) Appl. No.: 12/640,035

(22) Filed: Dec. 17, 2009

(51) Int. Cl. G06Q 10/00; G06F 3/00; G06F 17/30

(52) U.S. Cl. 705/28; 715/741; 707/805; 707/E17.005

(57) ABSTRACT

A sensor based inventory management system and method is disclosed. In one embodiment, a method of real time inventory management includes providing a communication backbone between an inventory system and an inventory management server. The method also includes communicating a signal generated by a sensor unit of a sensor based inventory bin of the inventory system to the inventory management server through an interface. In addition, the method also includes determining a quantity of an inventory item in the sensor based inventory bin by processing the signal using an algorithm through a processor of the inventory management server. The method also includes communicating a request to a supplier for updating the quantity of the inventory item in the sensor based inventory bin of the inventory system. The method further includes updating the quantity of the inventory item in the sensor based inventory bin of the inventory system.

### CLAIM OF PRIORITY

This application claims priority from This patent application claims priority from:

(1) U.S. Provisional patent application No. 60/854,997 titled “Capacitive Sensor Based Inventory Control” filed on Oct. 26, 2006.
(2) U.S. Provisional patent application No. 60/854,799 titled “Apparatus and Method of Weighing Indiscreet Volume using a Capacitive Sensing Technique”, filed on Oct. 27, 2006.
(3) U.S. Utility patent application Ser. No. 11/925,709 titled “capacitive sensor based inventory control”, filed on Oct. 27, 2007.
(4) PCT patent application titled “Capacitive Sensor Based Inventory Control” filed on Oct. 26, 2007.

### FIELD OF TECHNOLOGY

This disclosure relates generally to the technical fields of measuring devices and, in one embodiment, to a sensor based inventory management system and method.

### BACKGROUND

A supplier (e.g., a manufacturer, a distributor, a vendor) may be tasked with maintaining an adequate inventory stock level (e.g., raw material inventory, Work in Progress (WIP) inventory, a finished goods inventory). For example, the supplier may need to maintain adequate inventory levels at a point-of-use site of a customer. To accommodate this, the supplier may have to employ dedicated personnel. The personnel may spend time searching for and/or counting inventory levels. Counting inventory levels may take long periods of time. Thereby, leading to the consumption of time.

Further, the supplier may have to incur increased labor costs to pay and/or compensate the personnel performing manual inventory counts. In addition, the manual inventory counts may be inaccurate, since people involved in performing the tasks may have to physically move pallets creating work place hazards. For example, the physical tasks involved may lead to delay in order, to ship more inventories.

Furthermore, delayed inventory counts may lead to forecasting problems, insufficient production, excess production, and/or a loss of revenue.

### SUMMARY

A sensor based inventory management system and method is disclosed. In one aspect, a method of real time inventory management includes providing a communication backbone between an inventory system and an inventory management server. The method also includes communicating a signal generated by a sensor unit of a sensor based inventory bin of the inventory system to the inventory management server through an interface. In addition, the method also includes determining a quantity of an inventory item in the sensor based inventory bin by processing the signal using an algorithm through a processor of the inventory management server. The method also includes communicating a request to a supplier for updating the quantity of the inventory item in the sensor based inventory bin of the inventory system. The method further includes updating the quantity of the inventory item in the sensor based inventory bin of the inventory system.

In addition, the method includes generating the signal from the sensor unit based on weight of the inventory item in the sensor based inventory bin of the inventory system. The sensor unit of the sensor based inventory bin may be a load cell that is made of one or more of a capacitive sensor, resistive sensor, and an inductive based sensor. The interface of the sensor unit may include any of a Universal Serial Bus (USB) interface, a Recommended Standard (RS) interface, and an Ethernet interface. The algorithm may process the signal by converting the signal into a measurement value. The algorithm may also process the measurement value based on a standard scale provided by a vendor for each of the inventory item.

In addition, the method may include providing acknowledgement to the inventory management server through the inventory system by updating the quantity of the inventory item in the sensor based inventory bin of the inventory system. The aforementioned communication backbone may be made of a wired communication and/or a wireless communication to enable communication between the inventory system and the inventory management server. The method may also include configuring one or more of a maximum threshold, a minimum threshold and/or a critical value in the inventory management server for each of the inventory item in the inventory system. The critical value may be lesser than the minimum threshold. The method may also include generating a request to the supplier to update the quantity of the inventory item of the inventory system when the signal communicated to the inventory management server lesser than the minimum threshold, greater than the maximum threshold and/or around the critical value. In addition, the method may include communicating a request to the supplier through an electronic update (such as email, updating a social net work page (facebook etc), a Short Message Service (SMS), and/or a voice message.

The method may also include providing a communicational interface to enable communication with the inventory management server. The communicational interface may be any of an internet based Graphical User Interface (GUI) and a program generated GUI (such as Google chrome, Firefox, Safari, Internet Explorer etc.). The method may include providing access to users based on authentication to access administrative tools to a user to perform an administrative task. The administrative tasks may include one or more of modifying settings, management of information associated with sensor based inventory bins and associated inventory items, controlling flow of data and reports.

In addition, the method may include generating a report of any of inventory count, replenishment, and/or periodic consumption pattern. The method further includes optionally providing additional sensors in the sensor unit to detect and provide drift correction.

In another aspect, a method of inventory system includes providing a sensor unit of a sensor based inventory bin with an interface to communicate a signal to an advanced communication device based on a weight of an inventory item in the sensor based inventory bin. In addition, the method may include communicating a signal generated by the sensor unit of the sensor based inventory bin to the advanced communication device through a communication line coupled between the advanced communication device and interface of the sensor unit of the sensor based inventory bin.

The sensor unit of the sensor based inventory bin may be a load cell that includes one or more of a capacitive sensor, a resistive sensor, and an inductance based sensor. The interface of the sensor unit may include a Universal Serial Bus (USB) interface, a Recommended Standard (RS) interface, and an Ethernet interface. The method may include communicating the signals generated by each of the sensor based inventory bins to an inventory management server by the advanced communication device through any of a wired communication and/or a wireless communication. In addition, the method may include implementing a tilt correction in the sensor unit to enable the sensor unit to generate accurate signals based on weight of the inventory item. The method may also include optionally providing additional sensors in the sensor unit to detect and provide drift correction.

In yet another aspect, a system of inventory management includes an inventory system that includes one or more sensor based inventory bin. In addition, the system also includes a sensor unit of the sensor based inventory bin to generate a signal based on a weight of an inventory item placed in the sensor based inventory bin of the inventory system. The system also includes an advanced communication device to communicate the signal generated by the sensor units to an inventory management server through an interface. The system further includes the inventory management server to determine a quantity of the inventory item in the sensor based inventory bin using the signal obtained using a processor of the inventory management server, to communicate a request to a supplier for updating the quantity of the inventory item in the sensor based inventory bin of the inventory system, to generate a report that includes one or more of inventory count, replenishment, and/or periodic consumption pattern. In addition, the system includes the inventory management server to provide a communicational interface to a user. The communicational interface may be a an internet based Graphical User Interface (GUI) or a program generated GUI.

The aforementioned inventory system may be portable, wireless capable, power operated and battery operated. The sensor unit of the sensor based inventory bin may be load cell that is made of a capacitive sensor, resistive sensor, and an inductance based sensor. The interface of the sensor unit may be any of a Universal Serial Bus (USB) interface, a Recommended Standard (RS) interface, and an Ethernet interface. The request to the supplier may be an electronic update (such as email, updating a social net work page (facebook etc.), a Short Message Service (SMS), and a voice message.

The system may include an optional master communication device to provide communication between the inventory management server and plurality of advanced communication devices. In addition, the system may include a local inventory database communicatively coupled to the inventory management server to store values and information associated with each of the inventory items and associated sensor based inventory bins. The system may also include optional additional sensors in the sensor unit to detect and provide drift correction.

Other features will be apparent from the accompanying drawings and from the detailed description that follows.

### BRIEF DESCRIPTION OF THE VIEWS OF DRAWINGS

Example embodiments are illustrated by way of example and not limitation in the figures of accompanying drawings, in which like references indicate similar elements and in which:

FIG. 1 is a system view illustrating an automatic inventory management system, according to one or more embodiments.

FIG. 2 is an exploded view of an inventory management server, according to one or more embodiments.

FIG. 3 is a schematic view of an inventory bin, according to one embodiment.

FIG. 4 is a diagrammatic process flow illustrating the inventory management system, according to an example embodiment.

FIG. 5 is a schematic view that illustrates a wired backbone for communication in the inventory management system, according to one or more embodiment.

FIG. 6 is a user interface view generated by the inventory management server to administrator providing information associated with inventory items in the inventory system(s), according to one or more embodiments.

FIG. 7 is a diagrammatic system view of a data processing system in which any of the embodiments disclosed here in may be performed, according to one embodiment.

FIG. 8A is a process flow of real time inventory management, according to one embodiment.

FIG. 8B is a continuation of FIG. 8A illustrating additional operations, according to one embodiment.

FIG. 9 is a process flow of the inventory system management, according to one embodiment.

Other features of the present embodiments will be apparent from accompanying Drawings and from the Detailed Description that follows.

### DETAILED DESCRIPTION

A sensor based inventory management system and method is disclosed. Although the present embodiments have been described with reference to specific example embodiments, it will be evident that various modifications and changes may be made to these embodiments without departing from the broader spirit and scope of the various embodiments.

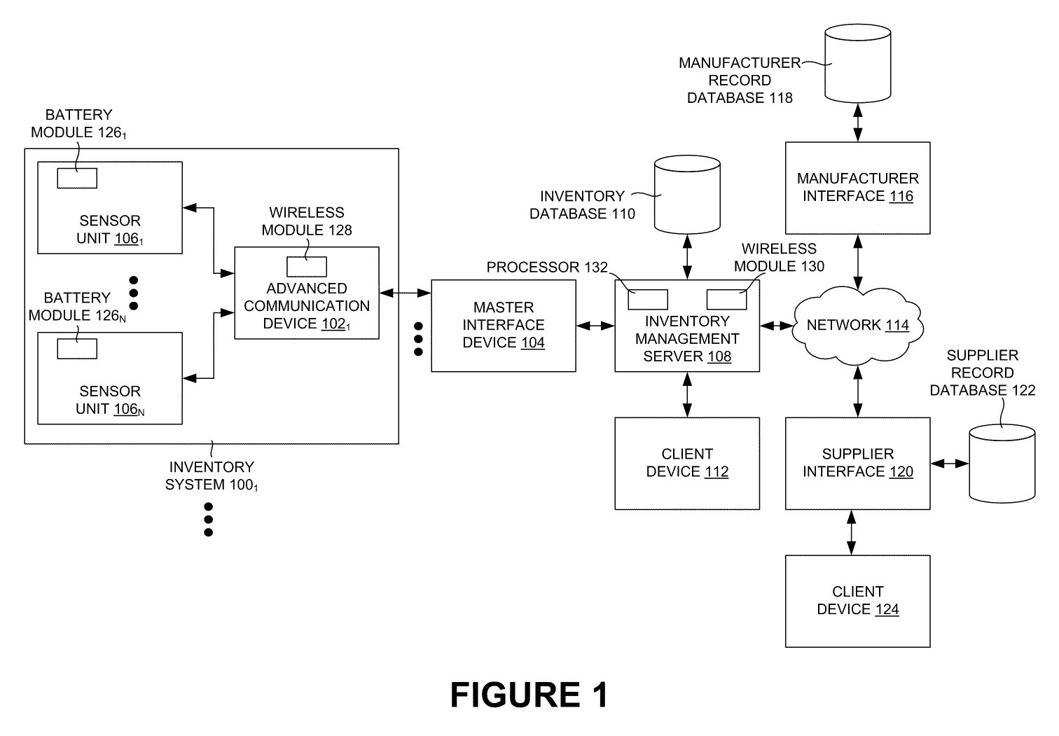

FIG. 1 is a system view illustrating an automatic inventory management system, according to one or more embodiments. In particular, FIG. 1 illustrates inventory system(s) 100_{1-N}, advanced communication device(s) 102_{1-N}, master interface device 104, sensor units 106_{1-N}, an inventory management server 108, an inventory database 110, a client device 112, a network 114, a manufacturer interface 116, a manufacturer record database 118, a supplier interface 120, a supplier record database 122, a client device 124, a battery module 126_{1-N}, a wireless module 128, a wireless module 130, a processor 132, according to one or more embodiments.

The inventory system 100_{1-N} may be a system that is used for managing a stock of collection of goods and materials (e.g., inventory items) in an enterprise (e.g., an industry, a shopping mall, a departmental store). In one or more embodiments, the inventory system 100_{1-N} described herein may be portable in nature with wireless communication capability. The management of goods and materials include, but not limited to auditing of the stock, determining requirements, excess goods, updating goods, generating statistics and consumer behavior. In one or more embodiments, the aforementioned inventory system 100_{1-N} may be used manage the quantity of stock. As illustrated, the inventory system 100_{1-N} may include sensor unit(s) 106_{1-N} for measuring weight of the goods in an inventory bin (e.g., industrial standard scales). The sensor unit(s) 106_{1-N} may be devices that generate a signal proportional to weight of the inventory item in the container of the inventory bin. The aforementioned sensor unit(s) 106_{1-N} may be structurally coupled to the inventory bins (not shown in figure) to form a weighing machine on the portable inventory system 100_{1-N}. In one or more embodiments, the sensors in the sensor unit 106_{1-N} may include, but not limited to a capacitive sensor, a resistive sensor, and an inductance sensor. In one or more embodiments, the sensor may be a load cell.

In one or more embodiments, the sensor unit(s) 106_{1-N} may also include the battery module(s) 126_{1-N}. The battery module 126_{1-N} may be used to power the sensor unit(s) 106₁. In one or more embodiments, the battery module 126_{1-N} inter alia may include a power regulator, a battery (e.g., lithium-ion), and power indicator. The power regulator may regulate the input power to the sensor unit(s) 106_{1-N} such that the sensor unit(s) 106_{1-N} receives adequate power for proper functioning. In addition, the power regulator may also prevent excess power from damaging the sensor unit(s) 106_{1-N}. In one or more embodiments, the battery described herein may be a rechargeable battery that can be recharged through a power chord provided thereof. In one or more embodiments, the sensor unit(s) 106_{1-N} may also be operated on direct power supply.

The sensor unit(s) 106_{1-N} may generate a signal based on the weight of the inventory item placed in the container of the inventory bin 302. The signal generated by the sensor unit(s) 106_{1-N} may be communicated to inventory management server 108 through the advanced communication device 102_{1-N} via the master interface device 104. The sensor unit(s) 106_{1-N} may communicate the signal through an interface (not shown in figure) in the sensor unit 106_{1-N}. The interface may include, but not limited to a RS-232 interface, a RS-422 interface, a RS-485 interface, an Ethernet interface, a daisy chain port, Universal Serial Bus (USB) port, and a Power over Ethernet (PoE) interface.

The advanced communication device 102_{1-N} (e.g., switch) may be a device to route the incoming signals from the sensor unit(s) 106_{1-N} to inventory management server 108. In one or more embodiments, the master interface device 104 (e.g., switch) may be required to route the signals from the advanced communication device 102_{1-N} to inventory management server 108. The master interface device 104 may be an optional device. The master interface device may not be required if there are limited number of inventory systems.

In one or more embodiments, the advanced communication device 102_{1-N} may include the wireless module 128 to communicate signals from the sensor units 106 to the inventory management server 108. The wireless communication may be through any of, but not limited to a Universal Serial Bus (USB) interface, a Bluetooth interface, a Zigbee interface, a WiFi interface, a WiMax interface, and a Wibree interface. In one or more embodiments, the inventory management server 108 may be supported by use of appropriate inventory management software. The inventory management software may be used to manage the inventory system. In one or more embodiments, the inventory management software functionalities may include, but not limited to may collection of data from the sensor units 106_{1-N}, processing the collected data into machine readable format, analyzing the converted data, comparing with the standard data in the inventory database 110, updating the inventory database 110 with the temporary data, analyzing the user/administrator requests, responding to the user/administrator requests, generate request for updating inventory system 100_{1-N}, communicate the requests to the supplier interface 120 and manufacturer interface 116, updating the status of the inventory system 100_{1-N} by updating the values in the inventory database 110 and generating statistics and reports. The inventory management server 108 may be communicatively coupled with the inventory database 110. The inventory database 110 may be a database (e.g., relational, hierarchical, etc.) that is used to support and manage information associated with inventory system 100_{1-N}. In one or more embodiments, the inventory database 110 may include database management system which oversees an inventory control of parts and/or components necessary for a management of inventory items in the inventory system 100₁. In one or more embodiments, the aforementioned information may include standard data associated with each of the inventory items in the inventory system 100_{1-N}, conversion scale of weights and number of items, etc. Furthermore, the inventory database 110 may include details of quantity of inventory items, a status, and/or order information of inventory items and/or the quantity of the inventory items located in the inventory system 100₁.

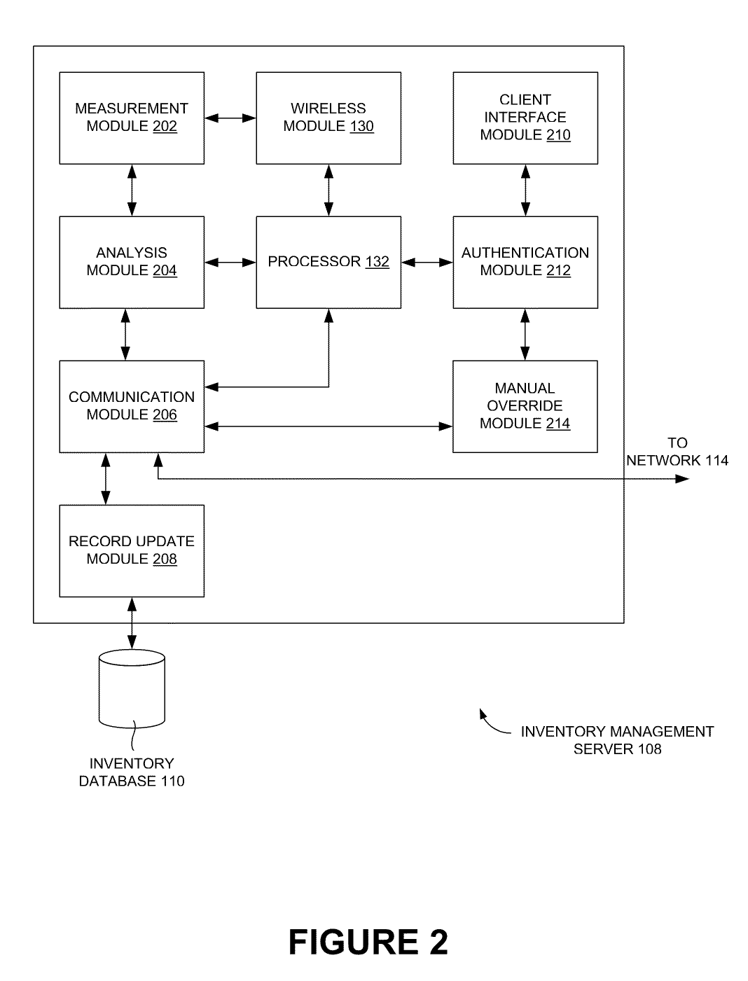

The inventory management server 108 may include several modules that is described in FIG. 2. An administrator (not shown in figure) of the enterprise may manage the inventory system 100_{1-N} manually through the client device 112 (e.g., a computer) by accessing the inventory management server 108. In one or more embodiments, the inventory management server 108 may provide communicational interfaces to users to enable communication with the inventory management server 108. The communicational interface may include, but not limited to a an internet based Graphical User Interface (GUI), and a program based GUI. The inventory management server 108 may provide secure access to the administrator to access administrative tools. The administrative tools may be functionalities provided to manage and control the working of the inventory management server 108. Furthermore, the administrative tasks may include managing settings, managing configurations, addition, removal and updating of new sensor based inventory bins and associated inventory items, controlling flow of data and reports, etc.

The inventory management server 108 may determine the quantity of the inventory item in the container of the inventory bin of the inventory system automatically and almost periodically (e.g., every 15 min, every 1 hour). In one or more embodiments, current status of the inventory items may be obtained from the inventory management server 108 and request for updating may be sent to the administrator. The administrator may inspect the status of the inventory items to forward the request for updating the inventory item to a supplier of the inventory item. The aforementioned request for updating the inventory item may include a request for addition of inventory items, a request for retaking excessive items, a request for complete replacement, etc. A threshold quantity value may be set. For example, the threshold quantity value may include a maximum threshold, a minimum threshold and a critical value. The request for updating the inventory items may be generated when the value of the inventory items are lesser than a minimum threshold and/or critical threshold, and/or greater than a maximum threshold. In one or more embodiments, the administrator may define more threshold values or reduce the number of threshold values.

In one or more embodiments, the inventory management server 108 may provide options to the administrator to configure the inventory management software in inventory management server 108 to directly communicate the request for updating the stock to the supplier/manufacturer. In one or more embodiments, there may be separate suppliers for the goods. The inventory management server 108 may be configured to communicate separate requests to separate suppliers. In one or more embodiments, the request to update the stock may be communicated through the network 114. The network 114 may be an Internet, an Ethernet, a Radio Frequency (RF) network, a telecommunications (e.g., mobile) network, a wide area network (WAN), a local area network (LAN) (e.g., using USB, Bluetooth, WiFi, Zigbee, etc.), a wireless network (e.g., Wi-Fi, Wi-Max, etc.), and/or a storage area network (SAN), etc. The communication of request to the supplier/manufacturer may be performed through an electronic update (such as email, updating a social net work page (facebook etc.), a Short Message Service (SMS), a voice message, etc.

The supplier interface 120 upon receiving the request communication from inventory management server 108 may evaluate the requirements of the inventory system 100_{1-N}. The supplier interface 120 may be a communication end of the supplier. For example, the supplier interface 120/the manufacturer interface 116 may be an email system, a mobile phone device, etc. The supplier record database 122 may be a database detailing a quantity, a status, and/or order information of parts and/or components from the enterprise. The manufacturer record database 118 may be a database (e.g., relational, hierarchical, etc.) detailing a quantity, a status, and/or order information of parts and/or components by a supplier/enterprise.

In one or more embodiments, the supplier interface 120 upon evaluation may update the inventory system 100_{1-N} or may communicate a new request to the manufacturer interface 116 for updating the inventory item in the inventory system 100_{1-N}. The manufacturer of the inventory items may directly update the inventory system 100_{1-N} or update the inventory system 100_{1-N} through the supplier. The updating process described herein may include, but not limited to replenishing the quantity of goods, replacing the quantity of goods, and reducing the quantity of goods. The inventory system 100_{1-N} may be updated by the supplier or the manufacturer. While performing updating process, an acknowledgement is provided to the inventory management server 108 through the inventory system 100_{1-N}. The sensor unit(s) 106-N may generate signals indicating current status, thereby indicating the inventory management server 108 about the quantity of the inventory item in the inventory bin.

In one or more embodiments, the inventory management server 108 may be configured to store relevant transactions and communications in the inventory database 110. In one or more embodiments, the inventory management server 108 may generate reports and/or statistics on sales, consumer behavior, consumption pattern, fast sales, trends, etc. based on data and transactions stored in the local inventory. The statistics and/or reports may enable the administrator to maximize profit and organize accordingly. In addition, the reports may provide data to surveys and consumers about the trends and sales, according to one embodiment.

Furthermore, the sensor unit 106_{1-N} may be provided with optional additional sensors to detect and provide drift correction. The additional sensors may include proximity sensors, vision sensors, etc. The drift may be because of sudden change in weight due to external factors such as loading or unloading. The drift can be detected by using additional sensors that detect presence of any object at the time of drift. The signal generated during drift may be generally ignored. In addition, a tilt correction may be provided in the sensor unit 106_{1-N} to enable the sensor unit to generate accurate signals based on weight of the inventory item. Tilt correction may enable correction of errors that may be caused due to imbalance or concentration of weight on one side of the inventory bin.

FIG. 2 is an exploded view of the inventory management server 108, according to one or more embodiments. Particularly, FIG. 2 illustrates a measurement module 202, an analysis module 204, a communication module 206, a record update module 208, a client interface module 210, an authentication module 212, and a manual override module 214, according to one embodiment.

The incoming signal from the sensor unit 106_{1-N} (e.g., through the advanced communication device 102_{1-N}, via the master interface device) may be converted into a digital value. In one or more embodiments, the measurement module 202 may convert the signal to a digital value. In one or more embodiments, the measurement module 202 may also manually acquire the signals from the sensor units 106_{1-N}. The generated value may be communicated to the analysis module 204. The analysis module 204 may apply an algorithm to process the value based on a standard scale provided by vendor. For example, a bolt may weigh 1 ounce as per manufacturer specification, therefore 10 bolts weighs 10 ounces, 10 ounces as per standard scale indicates presence of 10 bolts.

The algorithm may compare the generated value with the standard values stored in the inventory database 110 to determine the quantity of the inventory items in the inventory system 100_{1-N}. The quantity value of the inventory items obtained may be uploaded into the inventory database 110 by the record update module 208. Based on the quantity of the goods, a report may be generated by the analysis module 204. The report may be communicated to the enterprise administrator, the supplier interface 120, and/or the manufacturer interface 116. However, the administrator can configure the inventory management server 108 to communicate directly to the supplier interface 120 or the manufacturer interface 116 or only to the administrator module for approval for communication. The inventory management server 108 may also include the client interface module 210 that enables client devices to communicate with inventory management server 108. The client devices may include the client device 112 of the enterprise and/or the client device 124 via the network 114. The client devices may include a computer, a mobile phone, etc.

In one or more embodiments, the administrator may access the inventory management server 108 to view the status of the goods, for performing updates (e.g., including changing configurations, adding new goods and values, etc.). The inventory management server provides access based on authentication using the authentication module 212. The inventory management server 108 may also provide a manual override module 214 to enable the administrator to control and manage the process and activities of the inventory management server 108. The administrator may communicate with the inventory management server 108 using the client device such as computer, a mobile phone, etc. In one or more embodiments, the administrator may also communicate with inventory management server 108 through the network 114 (e.g., via the internet) from any part of the world. In one or more embodiments, individuals outside the enterprise (e.g., consumers, suppliers, manufacturers) may also view the goods and the quantity of goods available in the enterprise through the network 114 (e.g., via the internet) using the client device 124. In one or more embodiments, the inventory management server 108 may provide Graphical User Interface to access and view the goods in the inventory system 1001-N.

In one or more embodiments, the inventory management server 108 may also support plug and play configuration to enable addition of bins in the inventory system instantly. Necessary data associated with the good in the bin may be uploaded into the inventory management server 108 through the client device 112. Also, in one or more embodiments, the inventory management server 108 other software such as an Enterprise Resource Planning (ERP) software to provide an ease of use.

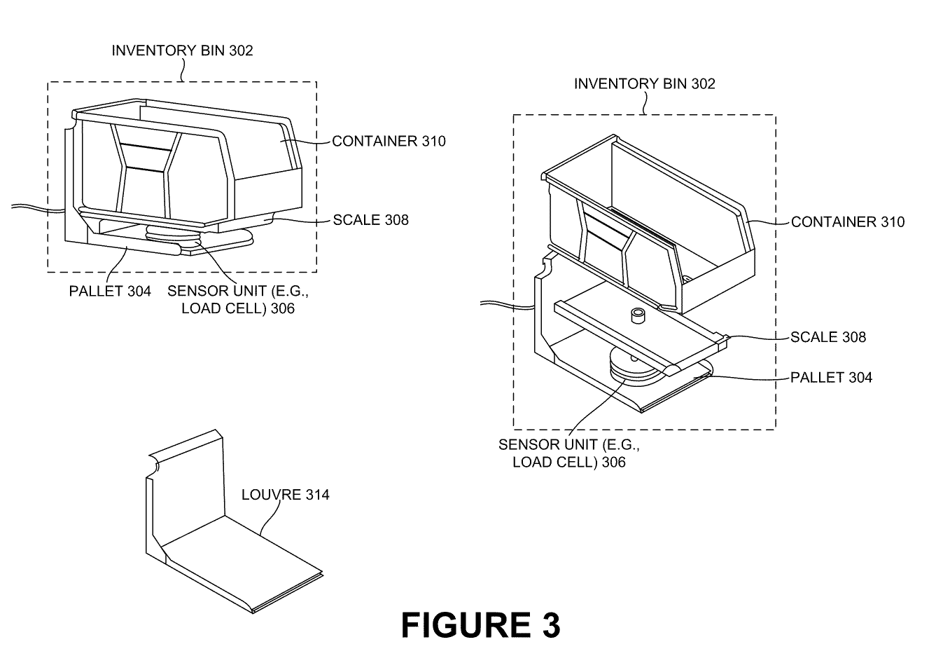

FIG. 3 is a schematic view of an inventory bin 302, according to one embodiment. In particular, FIG. 3 illustrates complete view and an assembled view of the inventory bin. The inventory bin 302 may be constructed by mounting a container 310 on the scale 308, the scale being coupled with the sensor unit 306 in an arrangement such that whenever any inventory items are placed in the container 310, there is a displacement within the sensor unit 306 varying the capacitance based on the weight in the container 310. The sensor unit 306 may be based on a pallet 304. The container 310, the scale 308, and the sensor unit 306 may all be supported by the pallet 304. One or more of the inventory bins may be used to form the inventory system 100_{1-N}. In addition, the inventory bin includes an interface for communication. The interface may include, but not limited to a RS-232 interface, a RS-422 interface, a RS-485 interface, an Ethernet interface, a daisy chain port, Universal Serial Bus (USB) port, and a Power over Ethernet (PoE) interface.

The inventory system 100_{1-N} may be structurally constructed as inventory kiosk, rails and racks, etc. However, it should be noted that the inventory system 100_{1-N} described herein are portable, mobile, and light weight. The inventory system 100_{1-N} described herein is structurally designed to fit into small areas, constant location changes, etc. However, the aforementioned inventory system 100_{1-N} may also be used in larger areas.

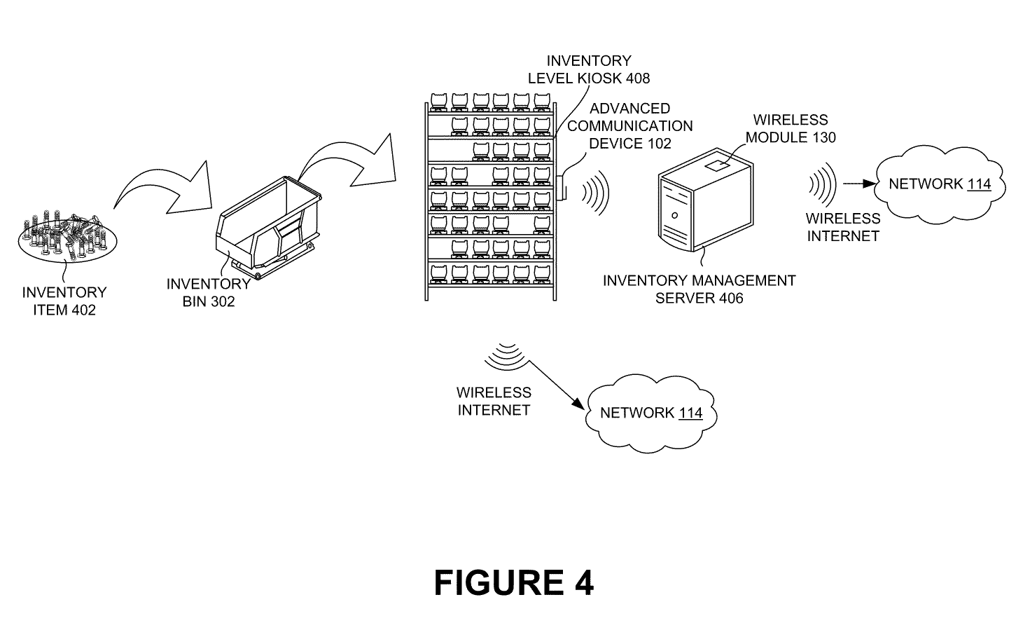

FIG. 4 is a diagrammatic process flow illustrating an inventory management system, according to an example embodiment. An inventory item 402 (e.g., goods as described before) may be transferred into the inventory bin 302. The inventory bin 302 may be placed in an inventory kiosk 408. Furthermore, the inventory bin 302 placed in the inventory kiosk 408 may be communicatively coupled to the advanced communication device 102 that is structurally coupled to the inventory kiosk 408. The wireless module 128 in the advanced communication device 102 may communicate the signal generated by the sensor unit(s) of the inventory bin 302 to the inventory management server 406. The inventory management server 406 may receive the signal and may generate a request based on requirements on comparison with standard values in the inventory database. Furthermore, the request may be communicated to the supplier interface/the manufacturer interface (e.g., through an electronic update (such as email, updating a social net work page (facebook etc.), message, SMS, etc.) through the network (e.g., internet). The supplier/manufacturer may respond by updating the inventory item 402 in the inventory system thereby acknowledging the request through updating the values in the inventory management system software via the inventory system (the inventory kiosk 408).

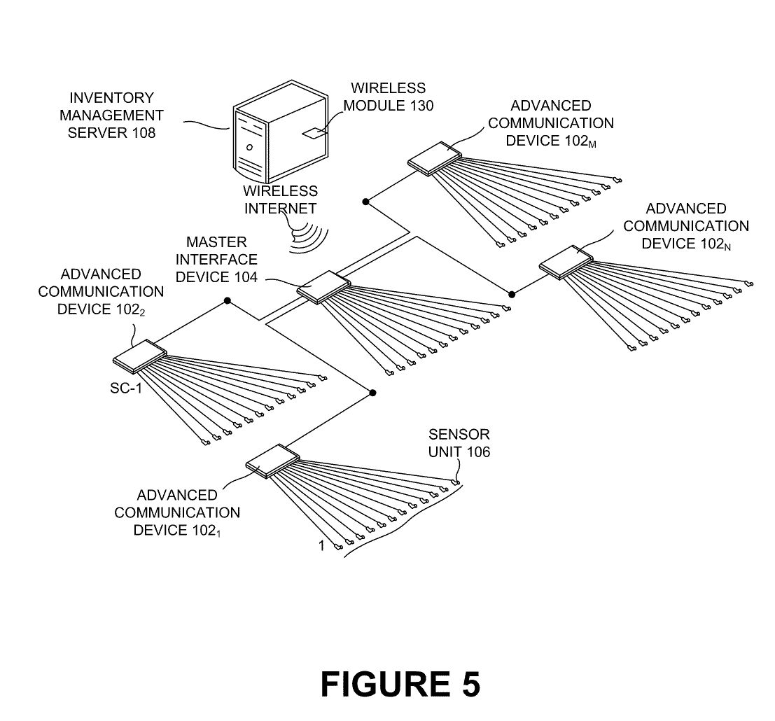

FIG. 5 is a schematic view that illustrates a wired backbone for communication in the inventory management system, according to one or more embodiment. The sensor unit(s) 106_{1-N} may be communicatively coupled the advanced communication device 102_{1-N} through an USB interface but not restricted to the USB interface. In one or more embodiments, the advanced communication devices 102_{1-N} in turn may be communicatively coupled to the master interface device 104. In one or more embodiments, the master interface device 104 may be required only when there are more than one advanced communication devices 102_{1-N} to couple with the inventory management server 108. The master interface device 104 may communicate the signals from each of the advanced communication devices to the inventory management server 108.

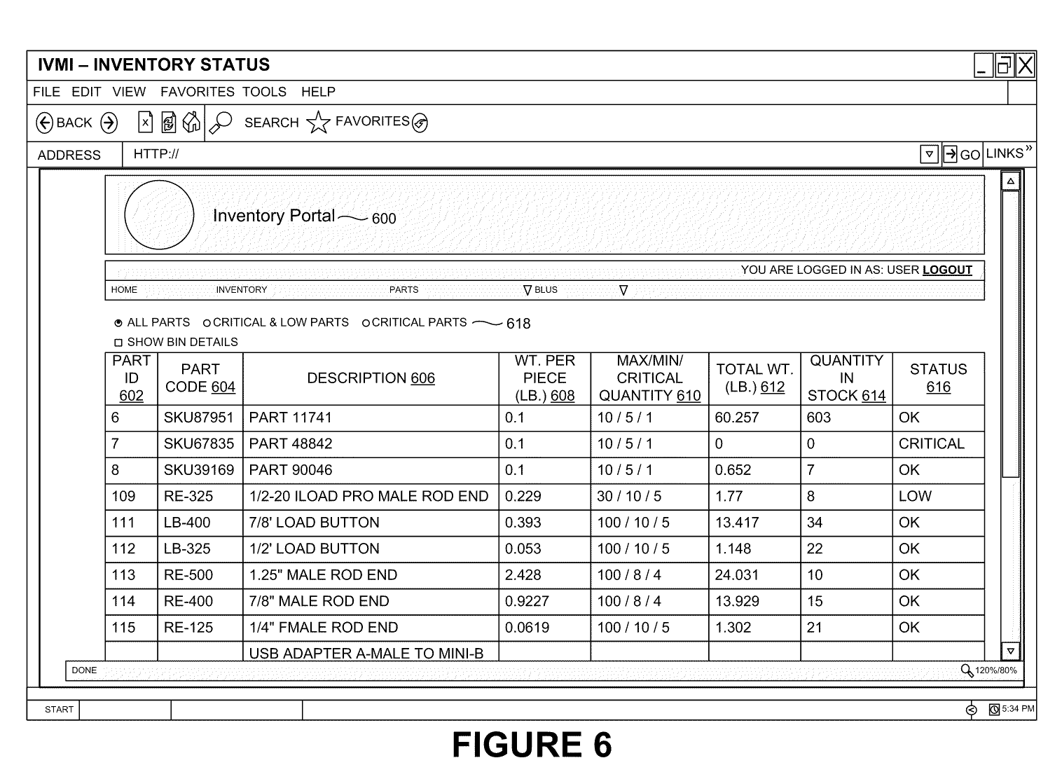

FIG. 6 is a user interface view generated by the inventory management server 108 to the administrator providing information associated with the inventory items in the inventory system(s), according to one or more embodiments.

The administrator may communicate with the inventory management server 108 to view the status of the inventory system 100_{1-N}. In one or more embodiments, the inventory management server 100_{1-N} may provide options and choices to the administrator to view the information. In an example embodiment, the inventory portal 600 may provide an option 618 to view the status of each of the inventory items in the inventory system. In the example embodiment, the inventory portal 600 illustrates “all parts, critical and low parts and critical parts” 616 option that enables the user to select an option to view the status of inventory items. Fields 602-616 illustrate details of the inventory items, and in particular to all parts, according to the example embodiment. The field 602 may illustrate part ID of the inventory item, the part code 604 field may illustrate the code name of the inventory item, the description 606 may provide information about the inventory item, and the weight per piece 608 field provides information about weight of the piece for each of the inventory item in the inventory bin. The max/min/critical quantity 610 field may provide the vendor defined threshold quantities of the inventory items required to be in the inventory bin, otherwise which a request be generated for updating the quantity. The field total weight 612 may illustrate the current weight in the inventory bin. The quantity in stock 614 field may illustrate the stock within the enterprise. The status field 616 may provide the status report of the inventory items in the inventory bin. In one or more embodiments, the inventory management server 108 may provide a different user interface for different users. For example, the inventory management software may provide a user interface to a consumer illustrating only available stocks in the enterprise.

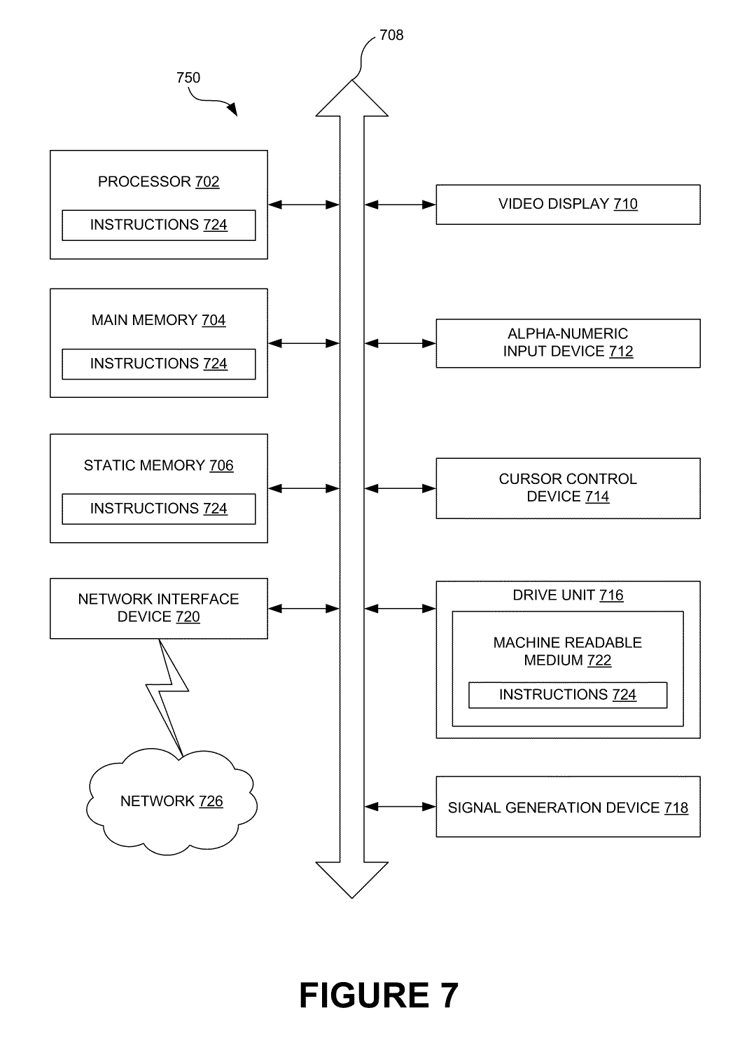

FIG. 7 is a diagrammatic system view 700 of a data processing system in which any of the embodiments disclosed here in may be performed, according to one embodiment. Particularly, the diagrammatic system view 700 of FIG. 7 illustrates a processor 702, a main memory 704, a static memory 706, a bus 708, a video display 710, an alpha-numeric input device 712, a cursor control device 714, a drive unit 716, a signal generation device 718, a network interface device 720, a machine readable medium 722, instructions 724, and a network 726, according to one embodiment.

The diagrammatic system view 700 may indicate a personal computer and/or the data processing system in which one or more operations disclosed herein are performed. The processor 702 may be a microprocessor, a state machine, an application specific integrated circuit, a field programmable gate array, etc. The main memory 704 may be a dynamic random access memory and/or a primary memory of a computer system.

The static memory 706 may be a hard drive, a flash drive, and/or other memory information associated with the data processing system. The bus 708 may be an interconnection between various circuits and/or structures of the data processing system. The video display 710 may provide graphical representation of information on the data processing system. The alpha-numeric input device 712 may be a keypad, a keyboard and/or any other input device of text (e.g., a special device to aid the physically handicapped).

The cursor control device 714 may be a pointing device such as a mouse. The drive unit 716 may be the hard drive, a storage system, and/or other longer term storage subsystem. The signal generation device 718 may be a bios and/or a functional operating system of the data processing system. The network interface device 720 may be a device that performs interface functions such as code conversion, protocol conversion and/or buffering required for communication to and from the network 726. The machine readable medium 722 may provide instructions 724 on which any of the methods disclosed herein may be performed. The instructions 724 may provide source code and/or data code to the processor 702 to enable any one or more operations disclosed herein.

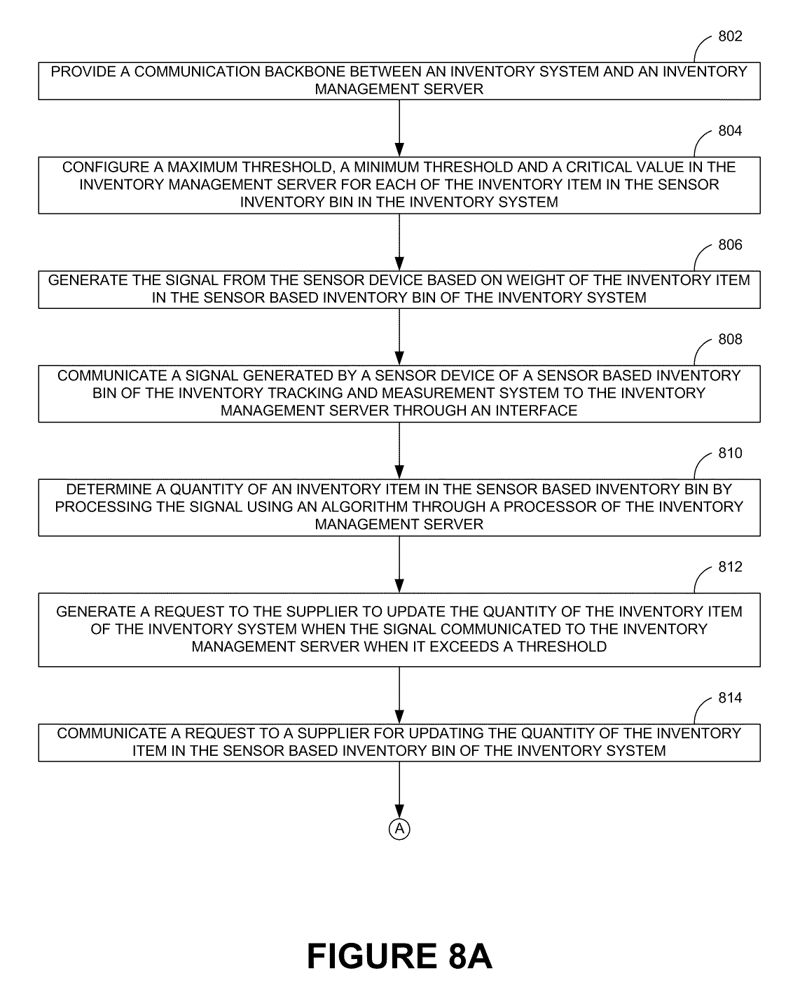

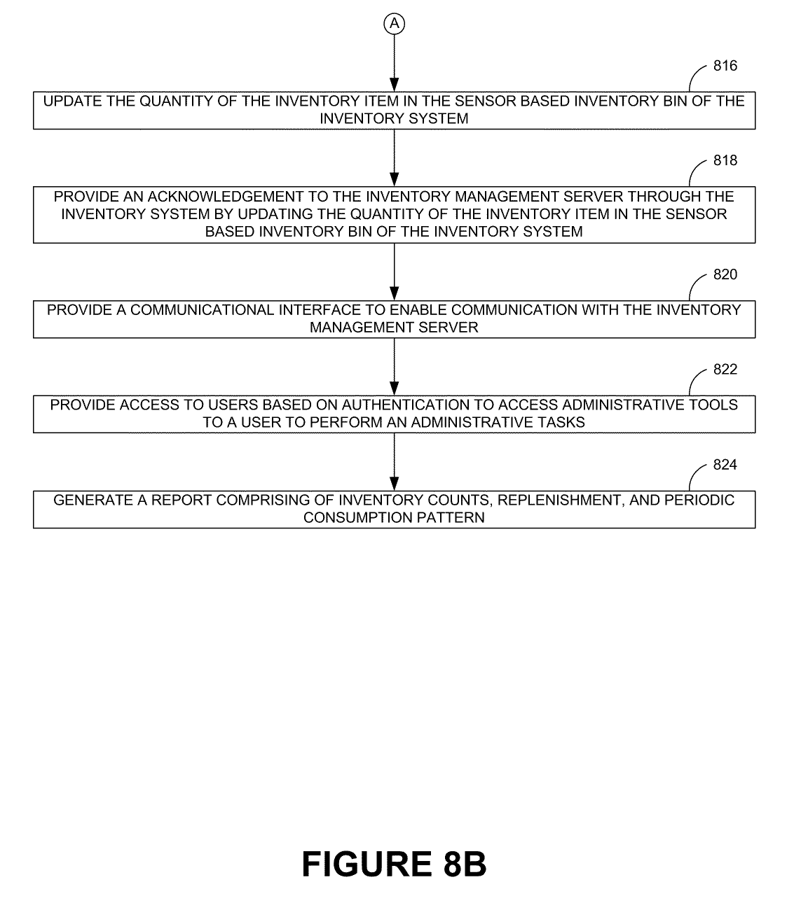

FIG. 8A is a process flow of real time inventory management, according to one embodiment. In operation 802, a communication backbone may be provided between the inventory system 100_{1-N} and the inventory management server 108. In operation 804, a maximum threshold, a minimum threshold and a critical value may be configured in the inventory management server 108 for each of the inventory item 402 in the inventory bin 302 in the inventory system 100_{1-N}. In operation 806, the signal from the sensor unit 106_{1-N} may be generated based on weight of the inventory item 402 in the inventory bin 302 of the inventory system 100_{1-N}. In operation 808, a signal generated by the sensor unit 106_{1-N} of the inventory bin 402 of the inventory system 100_{1-N} may be communicated to the inventory management server 108 through an interface (e.g., USB). In one or more embodiments, the inventory bin described herein is a sensor based inventory bin. In operation 810, a quantity of an inventory item 402 may be determined in the sensor based inventory bin by processing the signal using an algorithm through a processor of the inventory management server 108. In operation 812, a request may be generated to the supplier to update the quantity of the inventory item 402 of the inventory system 100_{1-N} when the signal communicated to the inventory management server 108 is lesser than the minimum threshold, greater than the maximum threshold and/or around the critical value. In operation 814, a request may be communicated to a supplier for updating the quantity of the inventory item 402 in the inventory bin 302 of the inventory system. In one or more embodiments, the request may be communicated to the supplier through any of an electronic update (such as email, updating a social net work page (facebook etc.), a Short Message Service (SMS), and a voice message.

FIG. 8B is a continuation of FIG. 8A illustrating additional operations, according to one embodiment. In operation 816, the quantity of the inventory item 402 may be updated in the sensor based inventory bin of the inventory system. In operation 818, an acknowledgement to the request may be provided to the inventory management server 108 through the inventory system 100_{1-N} by updating the quantity of the inventory item 402 in the inventory bin 302 of the inventory system 100_{1-N}. In operation 820, a communicational interface may be provided (e.g., as illustrated in FIG. 6) to enable communication with the inventory management server. In operation 822, access to users may be provided based on authentication to access administrative tools to perform administrative tasks. In operation 824, a report may be generated that includes one or more of inventory count, replenishment, and/or periodic consumption pattern.

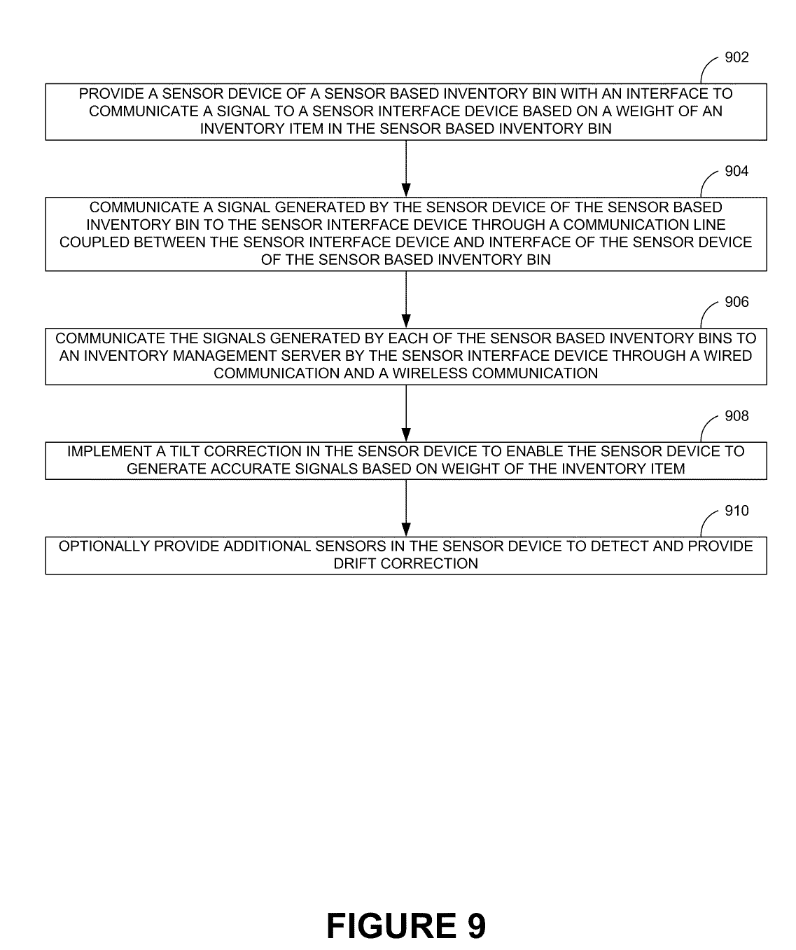

FIG. 9 is a process flow of the inventory system 100_{1-N} management, according to one embodiment. In operation 902, the sensor unit 106_{1-N} of the inventory bin 302 may be provided with an interface to communicate a signal to the advanced communication device 102 based on a weight of an inventory item 402 in the inventory bin 302. In operation 904, the signal generated by the sensor unit 106_{1-N} of the inventory bin 302 may be communicated to the advanced communication device 102 through a communication line coupled between the advanced communication device and interface of the sensor unit 106_{1-N} of the sensor based inventory bin. In operation 906, the signals generated by each of the sensor based inventory bins 302 may be communicated to the inventory management server 108 by the advanced communication device 102 through a wired communication and/or a wireless communication. In operation 908, a tilt correction may be implemented in the sensor unit 106_{1-N} to enable the sensor unit 106_{1-N} to generate accurate signals based on weight of the inventory item 402. In operation 910, additional sensors may be optionally provided in the sensor unit to detect and provide drift correction.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method of real time inventory management comprising:
providing a communication backbone between an inventory tracking and measurement system and an inventory management server;
communicating a signal generated by a sensor unit of a sensor based inventory bin of the inventory system to the inventory management server through an interface;
determining a quantity of an inventory item in the sensor based inventory bin by processing the signal using an algorithm through a processor of the inventory management server;
communicating a request at least to one of a user, a supplier and a distributor for updating the quantity of the inventory item in the sensor based inventory bin of the inventory system; and
updating the quantity of the inventory item in the sensor based inventory bin of the inventory system.

2. The method of claim 1, further comprising, generating the signal from the sensor unit based on weight of the inventory item in the sensor based inventory bin of the inventory system, wherein the sensor unit of the sensor based inventory bin is a load cell comprising of at least one of a capacitive sensor, resistive sensor, and an inductance based sensor, wherein the interface of the sensor unit comprises at least one of a Universal Serial Bus (USB) interface, a serial interface, an Ethernet interface, and a wireless (WiFi, WiMax, Blue tooth, Zigbee) interface.

3. The method of claim 1, wherein the algorithm to process the signal by converting the signal into a measurement value and processing the measurement value based on a standard scale provided by a vendor for each of the inventory item.

4. The method of claim 1, further comprising, providing an acknowledgement to the inventory management server through the inventory tracking and measurement system by updating the quantity of the inventory item in the sensor based inventory bin of the inventory tracking and measurement system.

5. The method of claim 1, wherein the communication backbone is comprised of at least one of a wired communication and a wireless communication to enable communication between the inventory tracking and measurement system and the inventory management server.

6. The method of claim 1, further comprising, configuring at least one of a maximum threshold, a minimum threshold and a critical value in the inventory management server for each of the inventory item in the sensor inventory bin in the inventory tracking and measurement system, wherein the critical value is lesser than the minimum threshold.

7. The method of claim 1, further comprising, generating a request at least to one of the user, the supplier and the distributor to update the quantity of the inventory item of the inventory tracking and measurement system when the signal communicated to the inventory management server is at least lesser than the minimum threshold, greater than the maximum threshold and around the critical value.

8. The method of claim 1, further comprising, communicating a request to the supplier through at least one of an electronic update, a Short Message Service (SMS), and a voice message.

9. The method of claim 1, further comprising providing a communicational interface to enable communication with the inventory management server, wherein the communicational interface is at least one of an internet browser based Graphical User Interface (GUI) and a program generated GUI.

10. The method of claim 9, further comprising, providing access to users based on authentication to access administrative tools to perform an administrative task, wherein the administrative tasks comprises of at least one of modifying settings, management of information associated with sensor based inventory bins and associated inventory items, controlling flow of data and reports.

11. The method of claim 1, further comprising generating a report comprising of at least one of inventory count, replenishment, and periodic consumption pattern.

12. The method of claim 1, further comprising optionally providing additional sensors in the sensor unit to detect and provide drift correction.

13. A method of an inventory system comprising:
providing a sensor unit of a sensor based inventory bin with an interface to communicate a signal to a advanced communication device based on a weight of an inventory item in the sensor based inventory bin; and
communicating a signal generated by the sensor unit of the sensor based inventory bin to the advanced communication device through a communication line coupled between the advanced communication device and interface of the sensor unit of the sensor based inventory bin.

14. The method of claim 13, wherein a sensor unit of the sensor based inventory bin is a load cell comprising of at least one of a capacitive sensor, resistive sensor, and an inductance based sensor, wherein the interface of the sensor unit comprises at least one of a Universal Serial Bus (USB) interface, a serial interface, an Ethernet interface, and a wireless (Wifi, WiMax, Blue tooth, Zigbee) interface.

15. The method of claim 13, further comprising, communicating the signals generated by each of the sensor based inventory bins to an inventory management server by the advanced communication device through at least one of a wired communication and a wireless communication.

16. The method of claim 13, further comprising, implementing a tilt correction in the sensor unit to enable the sensor unit to generate accurate signals based on weight of the inventory item.

17. The method of claim 13, further comprising, optionally providing additional sensors in the sensor unit to detect and provide drift correction.

18. A system of inventory management comprising:
an inventory system comprising at least one sensor based inventory bin;
a sensor unit of the sensor based inventory bin to generate a signal based on a weight of an inventory item placed in the sensor based inventory bin of the inventory tracking and measurement system;
an advanced communication device to communicate the signal generated by the sensor units to an inventory management server through an interface; and
the inventory management server:
to determine a quantity of the inventory item in the sensor based inventory bin using the signal obtained using a processor of the inventory management server;
to communicate a request to a user, a supplier and a distributor for updating the quantity of the inventory item in the sensor based inventory bin of the inventory system;
to generate a report comprising of at least one of inventory count, replenishment, and periodic consumption pattern; and
to provide a communicational interface to a user, wherein the communicational interface is at least one of an internet browser based Graphical User Interface (GUI) and a program generated GUI.

19. The system of claim 18, wherein the inventory system is portable, wireless capable, power operated and battery operated.

20. The system of claim 18, wherein the sensor unit is a load cell comprising of at least one of a capacitive sensor, resistive sensor, and an inductance based sensor, wherein the interface of the sensor unit comprises at least one of a Universal Serial Bus (USB) interface, a serial interface, an Ethernet interface, and a wireless (Wifi, WiMax, blue tooth, Zigbee) interface.

21. The system of claim 18, wherein the request to the supplier is at least one of an electronic update (such as email, updating a social net work page (facebook etc.), a Short Message Service (SMS), and a voice message.

22. The system of claim 18, further comprising an optional master communication device to provide communication between the inventory management server and plurality of advanced communication devices.

23. The system of claim 18, further comprising a local inventory database communicatively coupled to the inventory management server to store values and information associated with each of the inventory items and associated sensor based inventory bins.

24. The system of claim 18, further comprising, optional additional sensors in the sensor unit to detect and provide drift correction.
